(19) United States
(12) Patent Application Publication
(10) Pub. No.: US 2012/0223081 A1
(43) Pub. Date: Sep. 6, 2012

(54) Organizer Device with Three-Ring Binder Feature

(76) Inventor: Jonathan Levin, Philadelphia, PA (US)

(21) Appl. No.: 13/039,304

(22) Filed: Mar. 2, 2011

(51) Int. Cl. B65D 25/00; B42F 3/04

(52) U.S. Cl. 220/503; 220/505; 402/31

(57) ABSTRACT

An organizer device includes a top horizontal organizer (THO) section that rests on a top horizontal surface and a three-ring binder assembly. The THO section is an open top rectangularly-shaped box. The THO section includes at least one chamber to store and organize desktop items such as paper clips, clamps, tacks, small memory devices, etc. The THO section includes a bottom horizontal floor and supporting vertical walls with an open top. Nonetheless, one or more chambers may have a lid (not shown). The three-ring binder assembly includes a plurality of binder rings coupled to a binder strip or support plate. The plurality of binder rings has two portions that are configured to be opened and closed (pivoted away or toward each other) via a manually operable lever. The binder ring portions of a ring may be spring biased toward each other to a rings-closed position when the manually operable lever is in a first position.

### COPENDING APPLICATIONS

This application claims priority benefit of U.S. Provisional Application No. 61/339,240 titled “Organizer Device for a Computer Monitor”, filed on Mar. 2, 2010, and having the same inventor of the instant patent application and which is incorporated herein by reference as if set forth in full below; and

This application claims priority benefit of U.S. Provisional Application No. 61/340,686 titled “Organizer Device With Three-Ring Binder For A Computer Monitor,” filed Mar. 19, 2010, having the same inventor of the instant patent application and which is incorporated herein by reference as if set forth in full below.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

I. Field

The invention relates to organizers and storage systems.

II. Background

Monitors, keyboards, mouse pads and other Personal Computer (PC) interfaces are placed on the desktop thereby limiting the surface space that can be used for writing and storing other desktop items. There have been several attempts to create organizers for desks. However, other organizers are generally complicated and difficult to install or use. In particular, many computer user's complain that desktops do not have sufficient space to support paper when typing.

Therefore, there is a continuing need for an organizer device with three-ring binder rings for a computer monitor that is simple to install and use.

### SUMMARY

The aforementioned problems, and other problems, are reduced, according to exemplary embodiments, by the organizer device with three-ring binder rings for a computer monitor or another planar device (e.g. television, table top, edge of dresser, etc.), as described herein.

Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### BRIEF DESCRIPTION OF THE DRAWINGS

The above and other exemplary embodiments, objects, uses, advantages, and novel features are more clearly understood by reference to the following description taken in connection with the accompanying figures wherein:

FIG. 1A illustrates a perspective view of an organizer device with a three-ring binder assembly in accordance with some exemplary embodiments of the present invention;

FIG. 1B illustrates a perspective view of the organizer device of FIG. 1A installed to a computer monitor in accordance with some exemplary embodiments of the present invention;

FIG. 2 illustrates a perspective view of yet another organizer device with a three-ring binder assembly installed on a computer monitor in accordance with some exemplary embodiments of the present invention;

FIG. 3 illustrates a perspective view of yet another organizer device with a three-ring binder assembly installed on a computer monitor in accordance with some exemplary embodiments of the present invention;

FIG. 4A illustrates a perspective view of yet another organizer device with a three-ring binder assembly in accordance with some exemplary embodiments of the present invention;

FIG. 4B illustrates a perspective view of the organizer device of FIG. 4A installed to a computer monitor in accordance with some exemplary embodiments of the present invention;

FIG. 5A illustrates a perspective view of yet another organizer device in accordance with some exemplary embodiments of the present invention;

FIG. 5B illustrates a perspective view of the organizer device of FIG. 5A installed on a computer monitor in accordance with some exemplary embodiments of the present invention;

FIG. 6 illustrates a perspective view of yet another organizer device in accordance with some exemplary embodiments of the present invention;

FIG. 7 illustrates a perspective view of yet another organizer device in accordance with some exemplary embodiments of the present invention;

FIG. 8 illustrates a perspective view of yet another organizer device in accordance with some exemplary embodiments of the present invention;

FIG. 9 illustrates a perspective view of yet another organizer device in accordance with some exemplary embodiments of the present invention.

FIG. 10 illustrates a perspective view of yet another organizer device in accordance with some exemplary embodiments of the present invention; and

FIG. 11 illustrates a perspective view of yet another organizer device in accordance with some exemplary embodiments of the present invention.

FIG. 12 illustrates a perspective view of yet another organizer device in accordance with some exemplary embodiments of the present invention.

All dashed lines shown in the FIGURES represent hidden structures, walls, etc.

### DESCRIPTION

The word “exemplary” is used herein to mean “serving as an example, instance, or illustration.” Any configuration or design described herein as “exemplary” is not necessarily to be construed as preferred or advantageous over other configurations or designs.

This invention now will be described more fully hereinafter with reference to the accompanying drawings, in which exemplary embodiments are shown. This invention may, however, be embodied in many different forms and should not be construed as limited to the embodiments set forth herein. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or perspective views illustrating some of this invention. The functions of the various elements shown in the figures may vary in shape, attachment, size, and other physical features. Those of ordinary skill in the art further understand that the exemplary systems, and/or methods described herein are for illustrative purposes and, thus, are not intended to be limited to any particular named manufacturer or other relevant physical limitation (e.g., material).

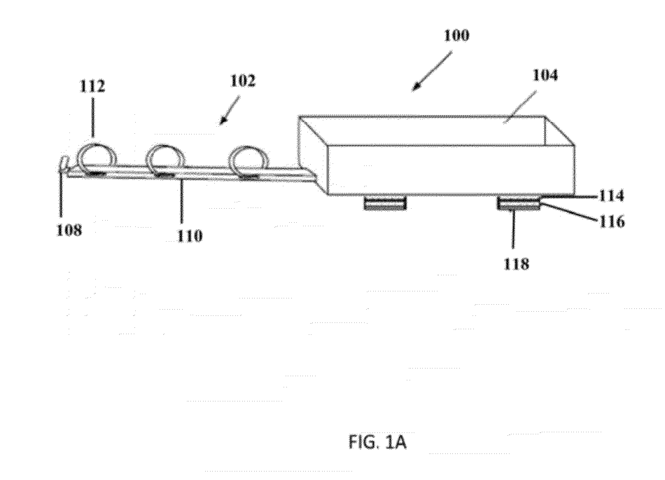

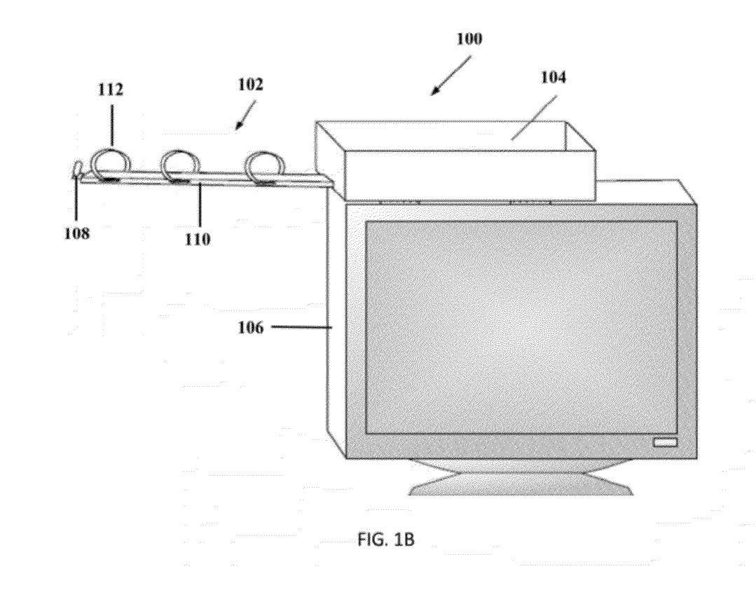

FIG. 1A and FIG. 1B illustrate a perspective view of an organizer device 100 with a three-ring binder assembly 102 installed on a computer monitor 106 in accordance with some exemplary embodiments of the present invention. The organizer device 100 may be attached to the computer monitor 106 via a hook fasten strip 114 and a loop fastener strip 116 (i.e., Velcro™ strips). The organizer device 100 is constructed and arranged to be attached to either side of the computer monitor 106.

The organizer device 100 includes a top horizontal organizer (THO) section 104 that rests on a top horizontal surface of the computer monitor 106 and a three-ring binder assembly 102. The THO section 104 is an open top rectangularly-shaped box. The THO section 104 includes at least one chamber to store and organize desktop items such as paper clips, clamps, tacks, small memory devices, etc. The THO section 104 includes a bottom horizontal floor and supporting vertical walls with an open top. Nonetheless, one or more chambers may have a lid (not shown).

The three-ring binder assembly 102 is an extension from or radiates from of a bottom floor of the THO section 104. The three-ring binder assembly 102 in an exemplary embodiment may serve as a side page organizer section to organizer, support and hold sheets of paper individually or in folders. The sheets that are coupled to the binder may be pocket folders with binder holes. The folders may hold papers or other sheets therein in an organized manner.

The three-ring binder assembly 102 includes a plurality of binder rings 112 coupled to a binder strip or support plate 110. The plurality of binder rings 112 has two portions that are configured to be opened and closed (pivoted away or toward each other) via a manually operable lever 108. The binder ring portions of a ring may be spring biased toward each other to a rings-closed position when the manually operable lever 108 is in a first position. The manually operable lever 108 when moved from the first position to a second position causes the binder ring portions to move away from each other to a rings-open position. The manually operable lever 108 may be pivotally mounted to the binder strip or support plate 110 for manual oscillating movement.

One side of the binder strip or support plate 110 includes the manually operable lever 108. In the exemplary embodiment, the one side corresponds to the distal end furthest from the THO section 104. However, the lever may be moved to the other end closest to the THO section 104. In the embodiment of FIGS. 1A and 1B, the plurality of rings 112 is closed. The plurality of rings 112 when opened move substantially in unison and simultaneously.

The plurality of binder rings 112 is oriented upward. However, the plurality of rings 112 may be oriented downward, or sideward.

The plurality of binder rings 112 is designed to receive protective transparent plastic sheets, loose leaf or other sheets of material. The protective transparent plastic sheet, cover or folder can be used to support a loose leaf sheet or other sheets therein.

During installation of the organizer device 100, an adhesive cover sheet 118 is removed from the loop fastener strip 116 to expose the adhesive layer on a bottom side of the loop fastener strip 116. The loop fastener strip 116 is then adhesively attached to the surface of the computer monitor 106 at a location that would align with the hook fastener strip 114 of the THO section 104 of the organizer device 100. As can be appreciated, instead of the loop fastener strip 116 being fastened to the computer monitor 106, the hook fastener strip 114 may be adhesively attached while the organizer device 100 has the loop fastener strip 116. When the organizer device 100 is sold, both the hook fasten strip 114 and the loop fastener strip 116 may be detached from the body of the organizer device 100 and later installed by the user. Thus, the location and number of the hook fasten strip 114 and loop fastener strip 116 is for illustrative purposes only. The strips may be longer and wider or otherwise varied.

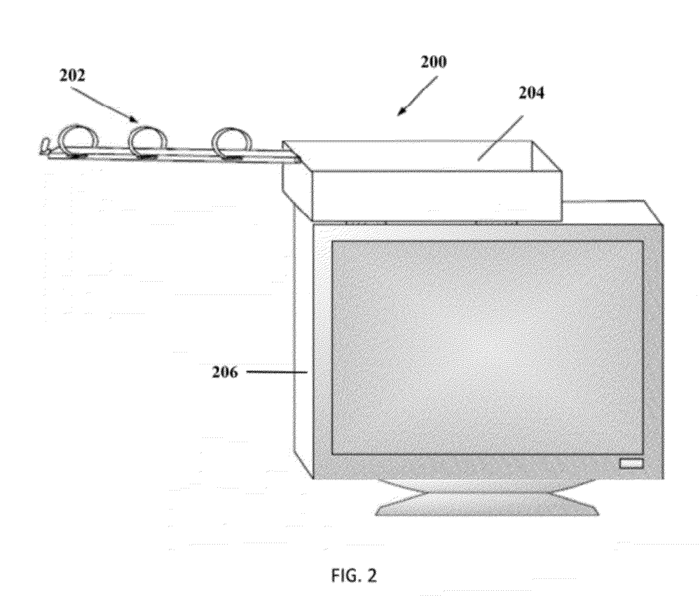

FIG. 2 illustrates a perspective view of yet another organizer device 200 with a three-ring binder assembly 202 installed on a computer monitor 206 in accordance with some exemplary embodiments of the present invention. The organizer device 200 of FIG. 2 is similar to the organizer device 100 of FIGS. 1A and 1B except that a three-ring binder assembly 202 is hingedly coupled to a top edge of a side wall of a THO section 204. Thus, the three-ring binder assembly 202 may be pivoted to a position which is on top of the THO section 204.

The hinged connection of the three-ring binder assembly 202 may be moved to other locations of the THO section 204. For example, the hinged connection may be placed on the back corner edge or front corner edge. If the hinged connection is placed at a corner edge, the three-ring binder assembly 202 may be pivoted in front or back of the THO section 204.

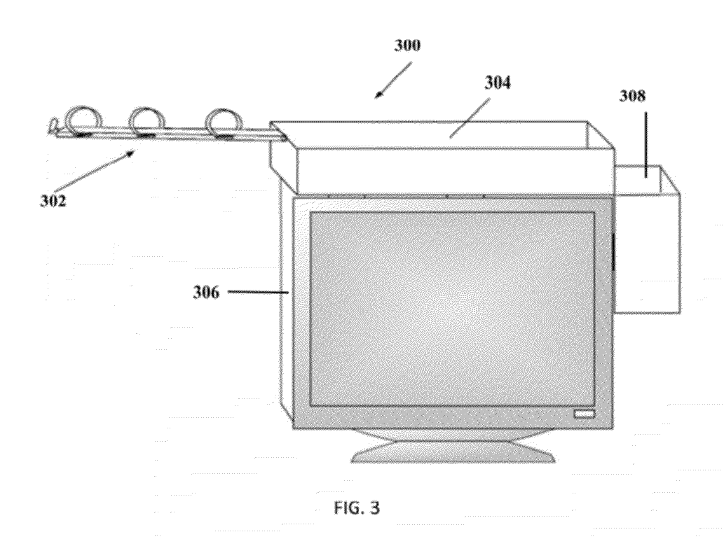

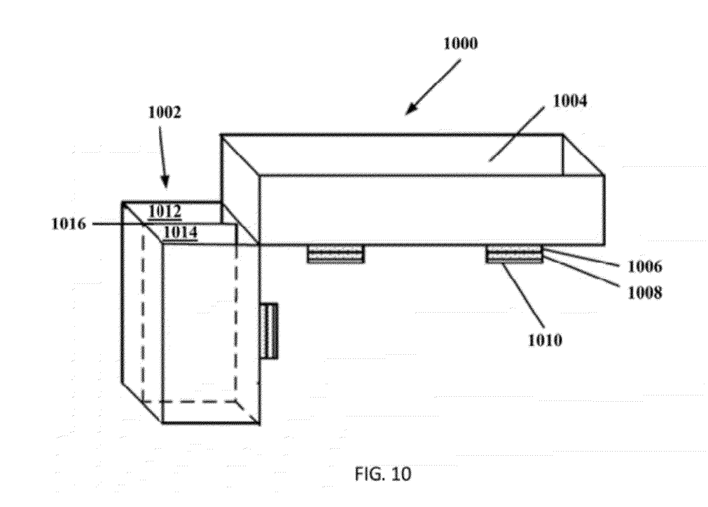

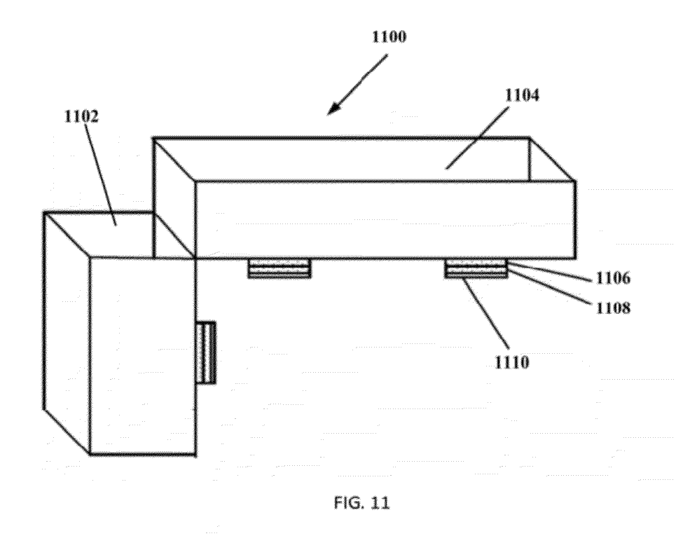

FIG. 3 illustrates a perspective view of yet another organizer device 300 with a three-ring binder assembly 302 installed on a computer monitor 306 in accordance with some exemplary embodiments of the present invention. The organizer device 300 of FIG. 3 is similar to the organizer device 200 of FIG. 2 except that the organizer device 300 includes both a THO section 304 and a VSO section 308. The VSO section 308 is described below in relation to FIGS. 10 and 11. Nonetheless other VSO section 308 designs described herein may be substituted.

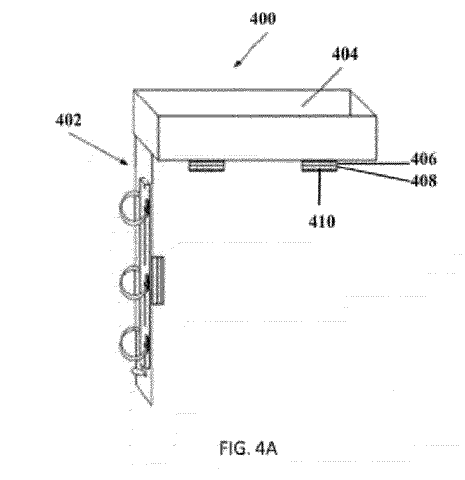

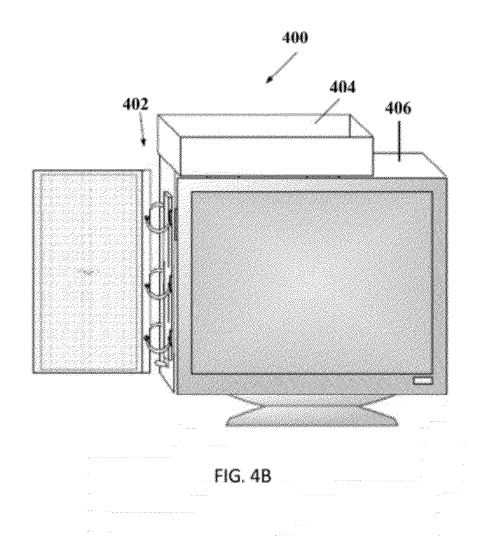

FIG. 4A illustrates a perspective view of yet another organizer device 400 in accordance with some exemplary embodiments of the present invention. The organizer device 400 of FIG. 4A is similar to the organizer device 100 of FIG. 1 except that a side page organizer section 402 forms an L-shape with a THO section 404. In other words, the side page organizer section 402 is positioned approximately 90 degrees (perpendicular) with respect to a bottom floor of the THO section 404.

FIG. 4B illustrates a perspective view of the organizer device 400 of FIG. 4A installed to a computer monitor 406 in accordance with some exemplary embodiments of the present invention. In FIG. 4B, transparent folder sheets supported by the side page organizer section 402 is shown. The dotted hatching represents a transparent material. A page (e.g., page 1) is inserted within the transparent folder sheet.

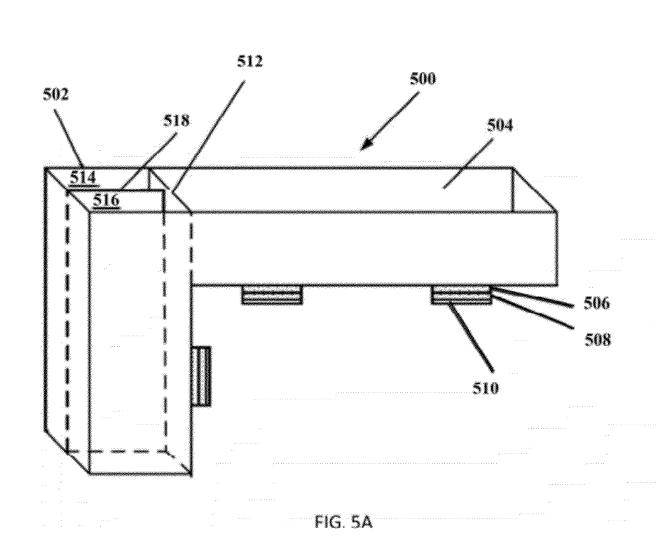

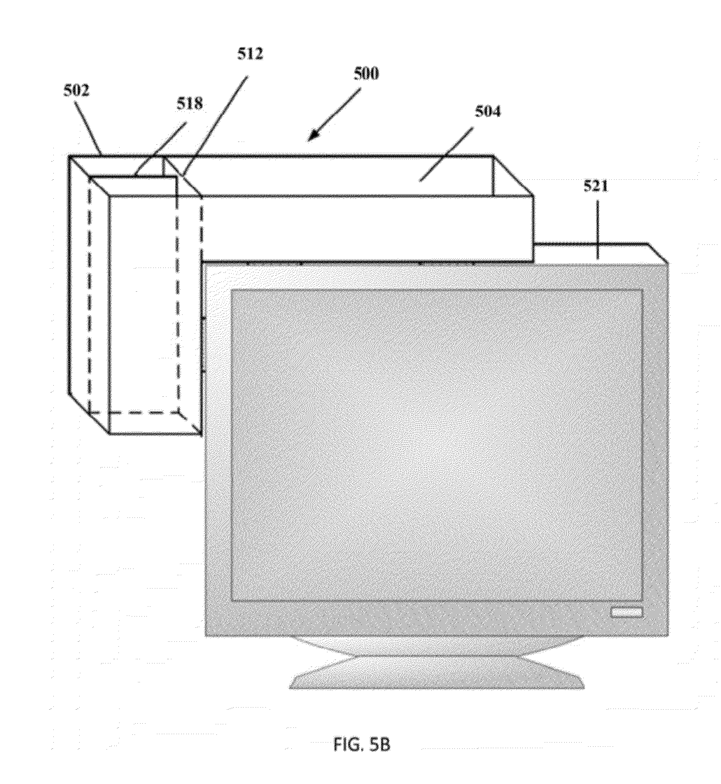

With reference to FIGS. 5A and 5B, there is shown an organizer device 500 configured to be attached to a respective one side of a computer monitor 521 in accordance with some exemplary embodiments of the present invention. The organizer device 500 may be attached to the computer monitor 521 via a hook fasten strip 506 and a loop fastener strip 508 (i.e., Velcro™ strips). The organizer device 500 is constructed and arranged to be attached to either side of the computer monitor 521.

The organizer device 500 is generally configured as an L-shape so that a THO section 504 of the organizer device 500 rests on a top horizontal surface of the computer monitor 521 while a VSO section 502 extends from and is integrated with the THO section 504 of the organizer device 500. In the exemplary embodiment, the THO section 504 and the VSO section 502 are configured to be affixed to the corresponding horizontal and vertical surfaces of the computer monitor 521, as best seen in FIG. 5A.

During installation, an adhesive cover sheet 510 is removed from the loop fastener strip 508 to expose the adhesive layer on a bottom side of the loop fastener strip 508. The loop fastener strip 508 is then adhesively attached to the surface of the computer monitor 508 at a location that would align with the hook fastener strip 506 of the THO section 504 or the VSO section 502 of the organizer device 500. As can be appreciated, instead of the loop fastener strip 508 being fastened to the computer monitor 521, the hook fastener strip 506 may be adhesively attached while the organizer device 500 has the loop fastener strip 508. When the organizer device 500 is sold, both the hook fasten strip 506 and loop fastener strip 508 may be detached from the body of the organizer device 500 and later installed by the user. Thus, the location and number of the hook fasten strip 506 and loop fastener strip 508 is for illustrative purposes only. The strips may be longer and wider or otherwise varied.

The THO section 504 includes at least one chamber to store and organize desktop items such as paper clips, clamps, tacks, small memory devices, etc. The THO section 504 includes a bottom horizontal floor and supporting vertical walls with an open top. Nonetheless, one or more chambers may have a lid (not shown).

The THO section 504 and the VSO section 502 share a section divider wall 512. The VSO section 502 is vertically elongated. The VSO section 502 includes a bottom horizontal floor and supporting elongated vertical walls with an open top. In the exemplary embodiment, the VSO section 502 may include two parallel side chambers SS1 514 and SS2 516 divided by a vertical divider wall 518. The VSO section 502 may have more than two parallel chambers to store elongated desktop items such as, without limitation, pencils, pens, glasses, remote control or other items of varying sizes.

The organizer device 500 may be adaptable wherein the vertical divider wall 518, configured to divide the VSO section 502, may be removed or installed in accordance with the user's preference or needs. Furthermore, more than one divider wall may be used to increase the number of side chambers.

The organizer device 500 of FIG. 5A may be installed on either side of the computer monitor 521. Alternatively, the organizer device 500 may be positioned on alternate surfaces, such as a television, a table top, an edge of a dresser, a vanity, and other surfaces that have a 90° angle.

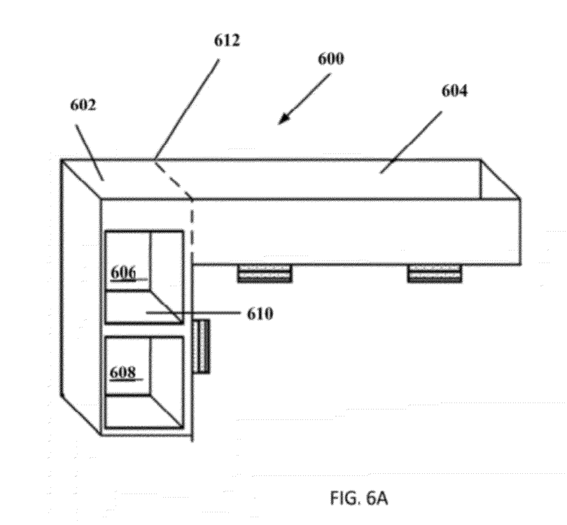

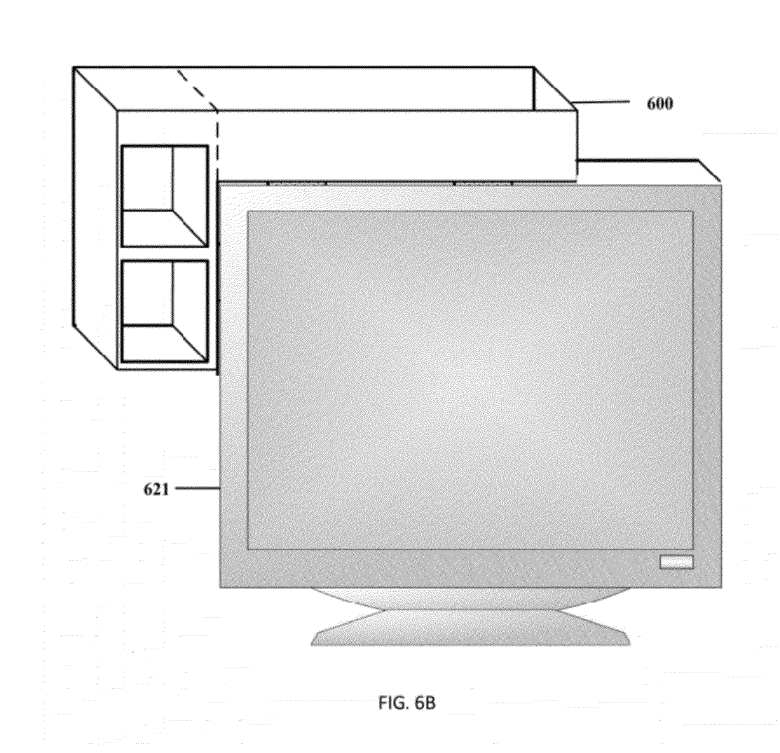

FIGS. 6A-6B there is shown yet another organizer device 600 configured to be attached to a respective one side of a computer monitor 621 in accordance with some exemplary embodiments of the present invention. The organizer device 500 of FIG. 5A and the organizer device 600 of FIG. 6A are generally the same thus only differences with be described in detail. A VSO section 602 in FIG. 6A includes vertically stacked chambers SS1 606 and SS2 608 wherein the chamber SS1 606 is vertically stacked above the chamber SS2 608. The VSO section 602 includes a bottom horizontal floor and supporting elongated vertical walls with a closed top. In the exemplary embodiment, the VSO section 602 may include two open front side chambers SS1 606 and SS2 608 divided by a horizontal divider wall 610. The side chambers SS1 606 and SS2 608 may store post-it notes, compact disc (CD) cases, digital video disc (DVD) cases, or other varying shape items. The VSO section 602 may have more than two parallel side chambers.

In an alternate exemplary embodiment, the horizontal divider wall 610 of FIG. 6A may be removable instead of integrated. For example, the horizontal divider walls 610 may be slid in and out of channels (not shown) to add a side chamber or change the height of a side chamber.

The organizer device 600 of FIG. 6A is installed on a side of the computer monitor 621 that would place the open front of the chambers adjacent to the screen of the computer monitor 621. For example, in the exemplary embodiment, the organizer device 600 is installed on the left hand side of the computer screen (as a frame of reference, when looking at the computer screen).

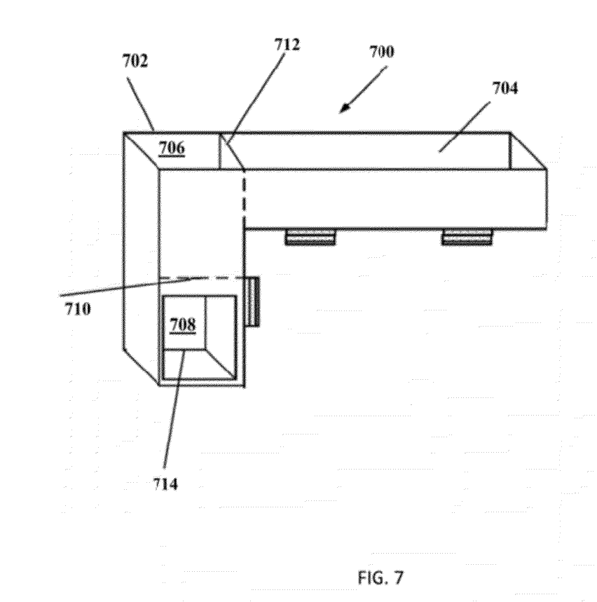

FIG. 7 illustrates a perspective view of yet another organizer device 700 in accordance with some exemplary embodiments of the present invention. The organizer device 600 of FIG. 6A and the organizer device 700 of FIG. 7 are generally the same thus only differences with be described in detail. A VSO section 702 in FIG. 7 includes vertically stacked chambers SS1 706 and SS2 708 wherein the chamber SS1 706 is vertically stacked above the chamber SS2 708. The VSO section 702 includes a bottom horizontal floor and supporting elongated vertical walls with a closed top. In the exemplary embodiment, the VSO section 702 may include one open top chamber SS1 706 and one open front side chamber SS2 708. The open top chamber SS1 706 is divided by a horizontal divider wall 710 from the open front side chamber SS2 708. The side chambers SS1 706 and SS2 708 may store post-it notes, compact disc (CD) cases, digital video disc (DVD) cases, or other varying shape items. The VSO section 702 may have more than two side chambers.

The horizontal divider wall 710 dividing the chambers SS1 706 and SS2 708 is located at a location below the bottom floor of the THO section 704. The chamber SS1 706 is vertically elongated with respect to the height of the chamber of the THO section 704.

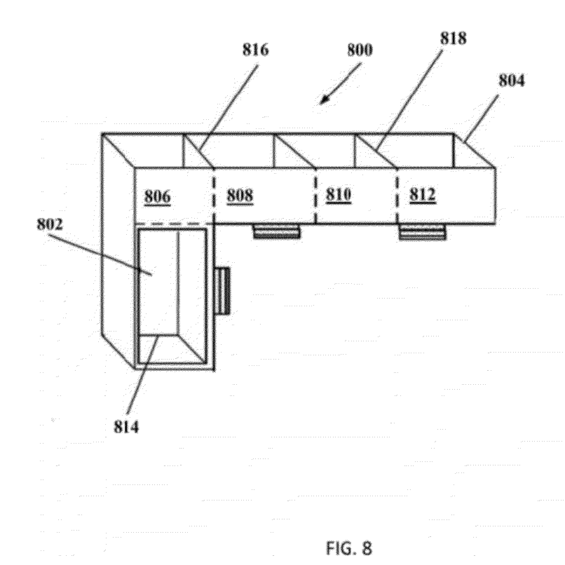

FIG. 8 illustrates a perspective view of yet another organizer device 800 in accordance with some exemplary embodiments of the present invention. FIG. 8 is similar to FIG. 7, therefore only differences will be described in detail. A TSO section 804 in FIG. 8 includes a plurality of horizontally aligned open top chambers TS1 806, TS2 808, TS3 810 and TS4 812. However, any one or more of the open top chambers may have a lid. The chambers TS1 806, TS2 808, TS3 810 and TS4 812 are positioned, when the organizer device 800 is installed, across the top horizontal surface of the computer monitor. The chambers may extend across the full length of the monitor or across only a portion of the length.

Chamber TS1 806 has vertically stacked thereunder at least one open front cavity 814 associated with a VSO section 802. The VSO section 802 includes a bottom horizontal floor and supporting elongated vertical walls with a closed top. The closed top corresponds to the bottom floor of chamber TS1 806 of the THO section 804. A divider wall may be used to further divide the open front cavity 814.

The chambers TS1 806 may be viewed as part of the VSO section 802 or the THO section 804. The divider walls dividing the chambers TS2 808, TS3 810 and TS4 812 may be removable.

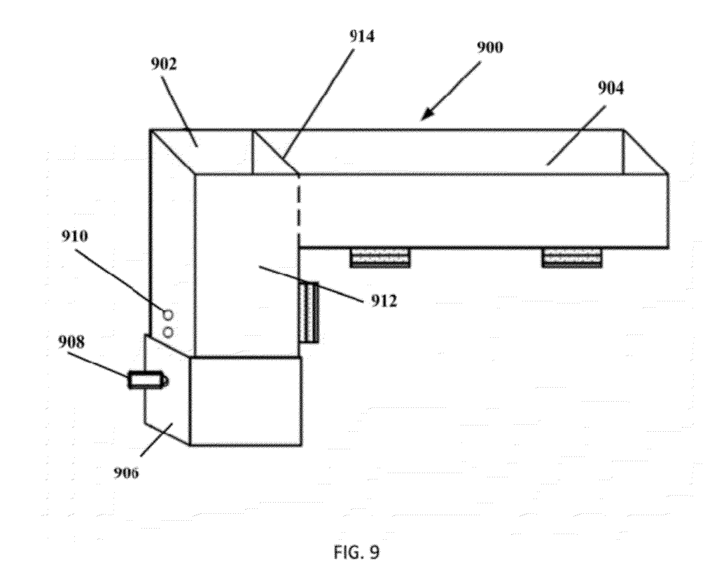

FIG. 9 illustrates a perspective view of yet another organizer device 900 in accordance with some exemplary embodiments of the present invention. FIG. 9 is similar to FIG. 5A, thus only the differences will be described in detail. In FIG. 9, a VSO section 902 has a vertically elongated chamber 912 which is adjustable in length. The VSO section includes supporting elongated vertical walls with an open top and open bottom. The bottom of the VSO section 902 is closed by a slide chamber 906 that surrounds the outer perimeter of the supporting elongated vertical walls of the VSO section 902. The slide chamber 906 has an open top and a closed bottom and vertical walls. The slide chamber 906 is secured in place via a spring-biased securing knob 908. The securing knob 908 is spring biased to a locking or securing position in a respective one of a plurality of holes 910 formed in a side vertical wall of the VSO section 902. When pulling the securing knob 908 out of one of the holes 910, the slide chamber 906 may be lowered or raised to vary the length of the chamber of the VSO section 902. When the securing knob 908 is released, it would be inserted into a corresponding one of the holes 910 in the side vertical wall of the VSO section 902.

As can be appreciated, other mechanisms to adjust the position of the slide chamber 906 with respect to the bottom the VSO section 902 may be used.

The organizer device 900 may be molded from any suitable material such as plastic or the like.

The material of the organizer device 900 may include transparent plastic. The material may include colored plastic but remain transparent. Nonetheless, other materials, transparent or opaque may be used of varying colors.

The organizer device 900 may be made of natural material, man-made material or a combination of natural and man-made materials.

In an exemplary embodiment, the height of the THO section 904 is two (2″) inches. The full length of the organizer device 900 from end to end is ten (10″) inches. The full height of the organizer device 900 may be six (6″) inches. As one of ordinary skill appreciates, alternate dimensions may be used such that the organizer can be manufactured to fit a range of surface areas.

FIG. 10 illustrates a perspective view of yet another organizer device 1000 in accordance with some exemplary embodiments of the present invention. The organizer device 1000 of FIG. 10 is constructed and arranged to be attached to either side of the computer monitor. The organizer device 1000 is generally configured as an L-shape so that a THO section 1004 of the organizer device 1000 rests on a top horizontal surface of the computer monitor while a VSO section 1002 extends from and is integrated with the THO section 1004 of the organizer device 1000. In the exemplary embodiment, the THO section 1004 and the VSO section 1002 are configured to be affixed to the corresponding horizontal and vertical surfaces of the computer monitor 521, as best seen in FIG. 5B or Appendix B. At least one manner of installation has been described above in relation to FIG. 5B, and as appreciated by one of ordinary skill in the art, alternate installation components exist for positioning the organizer device 1000.

The THO section 1004 includes at least one chamber to store and organize desktop items such as paper clips, clamps, tacks, small memory devices, etc. The THO section 1004 includes a bottom horizontal floor and supporting vertical walls with an open top. Nonetheless, one or more chambers may have a lid (not shown).

The VSO section 1002 is vertically elongated. The VSO section 1002 includes a bottom horizontal floor and supporting elongated vertical walls with an open top. In the exemplary embodiment, the VSO section 1002 may include two parallel side chambers SS1 1012 and SS2 1014 divided by a vertical divider wall 1016. The VSO section 1002 may have more than two parallel chambers to store elongated desktop items such as, without limitation, pencils, pens, glasses, remote control or other items of varying sizes.

The organizer device 1000 may be adaptable wherein the divider wall 1016, configured to divide the VSO section 1002, may be removed or installed in accordance with the user's preference or needs. Furthermore, more than one divider wall may be used to increase the number of side chambers.

The organizer device 1000 of FIG. 10 is similar to the organizer device 500 of FIG. 5A except that the top edge of the supporting elongated vertical walls of the VSO section 1002 is essentially flush or aligned with a horizontal plane of the bottom floor of the THO section 1004.

In general the top edge of VSO section 1002 may be below the top edge of the vertical walls of the THO section 1004.

In the exemplary embodiment, inside surfaces of the VSO section 1002 and the THO section 1004 (wherein the inside surfaces have the hook and loop fasteners placed thereon) are integrated together to form an “L”.

When the organizer device 1000 of FIG. 10 is installed, the THO section 1004 ends at substantially at a distal or corner of the computer monitor. The top or opening into the VSO section 1002, when installed, would begin at a location that corresponds substantially to the horizontal plane of the top of the computer monitor.

FIG. 11 illustrates a perspective view of yet another organizer device 1100 in accordance with some exemplary embodiments of the present invention. FIG. 11 is similar to FIG. 10 except that the VSO section 1102 does not have a vertical divider wall. The organizer device 1100 in FIG. 11 may be attached, mounted or secured to a computer monitor in the manner similar to that shown in Appendix B or FIG. 5B.

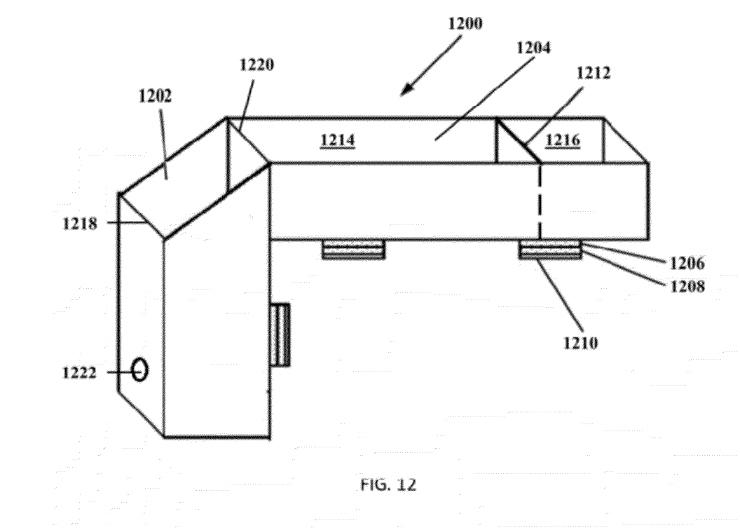

FIG. 12 illustrates a perspective view of yet another organizer device 1200 in accordance with some exemplary embodiments of the present invention. The organizer device 1200 of FIG. 12 is constructed and arranged to be attached to either side of the computer monitor. The organizer device 1200 is generally configured as an L-shape so that a THO section 1204 of the organizer device 1200 rests on a top horizontal surface of the computer monitor while a VSO section 1202 extends from and is integrated with the THO section 1204 of the organizer device 1200. In the exemplary embodiment, the THO section 1204 and the VSO section 1202 are configured to be affixed to the corresponding horizontal and vertical surfaces of the computer monitor as best seen in FIG. 5B or Appendix B. The manner of installation has been described above in relation to FIG. 5B

The THO section 1204 may include two horizontally aligned open top chambers TS1 1214 and TS2 1216 divided by a vertical divider wall 1212. The THO section THO 1204 many have more than two side chambers to store and organize desktop items such as paper clips, clamps, tacks, small memory devices, etc. The THO section 1204 includes a bottom horizontal floor and supporting vertical walls with an open top. The vertical divider wall 1212 dividing the chambers TS1 1214 and TS2 1216 may be removable. Nonetheless, any one or more of the open top chambers may have a lid (not shown).

The VSO section 1202 is vertically elongated. The VSO section 1202 includes a bottom horizontal floor and supporting elongated vertical walls with an open top. A top edge 1218 of the VSO section 1202 is below the horizontal top floor of the THO section 1204. And another top edge 1220 of the VSO section 1202 is aligned with the horizontal top floor of the THO section 1204. The VSO section 1202 may be used to store elongated desktop items such as, without limitation, pencils, pens, glasses, remote control or other items of varying sizes. As shown in the FIG. 12, a side aperture 1212 on the elongated wall of the VSO section 1202 allows the cables of various devices and utilities stored in the VSO section 1202 to conveniently pass through the VSO section 1202.

While the invention has been particularly shown and described with references to a preferred embodiment thereof, it will be understood by those skilled in the art that various changes in form and details may be made therein without departing from the spirit and scope of the invention.

What is claimed is:

1. An apparatus, comprising:
a first organizer section attached to at least one surface of a display device; and
a second organizer section attached to at least one surface of the display device.

2. The apparatus of claim 1, further comprising a side page organizer section to hold at least one sheet of paper.

3. The apparatus of claim 1, wherein the first organizer section is attached to the display device via a hook fastener strip and a loop fasten strip.

4. The apparatus of claim 3, wherein the first organizer section rests on a top horizontal surface of the display device.

5. The apparatus of claim 4, wherein the first organizer section includes a plurality of side chambers divided by at least one vertical wall divider.

6. The apparatus of claim 5, wherein the at least one vertical wall divider comprises at least one removable vertical wall divider.

7. The apparatus of claim 5, wherein the at least one of the plurality of side chambers comprises a chamber having an open top surface, a chamber having an open side surface chamber, or a chamber having an open front surface chamber.

8. The apparatus of claim 7, further comprising a hinged lid.

9. The apparatus of claim 1, wherein the second organizer section rests on a vertical surface of the display device.

10. The apparatus of 1, wherein the second organizer section extends from and is integrated with the first organizer section.

11. The apparatus of claim 10, wherein the first organizer section and the second organizer section are integrated as an L-shape and further comprise a sectional divider wall.

12. The apparatus of claim 11, wherein a top edge of at least one supporting elongated vertical wall of the second organizer section is aligned with or below a horizontal top floor of the first organizer section.

13. The apparatus of claim 1, wherein the second organizer section includes a bottom horizontal floor and a plurality of supporting elongated vertical walls, each of the plurality of supporting elongated vertical walls having an open top.

14. The apparatus of claim 1, wherein the second organizer section includes a bottom horizontal floor and a plurality of supporting elongated vertical walls with a closed top.

15. The apparatus of claim 1, wherein the second organizer section includes a plurality of supporting elongated vertical walls with an open top and open bottom.

16. The apparatus of claim 1, wherein at least one side aperture is on at least one supporting elongated vertical walls of the second organizer section.

17. The apparatus of claim 1, wherein the second organizer section includes a plurality of side chambers divided by at least one removable vertical divider wall.

18. The apparatus of claim 1, wherein the second organizer section is closed by a side chamber with an open top, a closed bottom and a plurality of vertical walls that surrounds the outer perimeter of the plurality of supporting elongated vertical walls of the second organizer section.

19. The apparatus of claim 18, wherein the slide chamber is secured in place via a securing knob that is spring biased to a locking position in a respective aperture formed in a side vertical wall of the second organizer section.

20. The apparatus of claim 2, wherein the side page organizer section includes a plurality of binder rings coupled to a binder strip or support plate and wherein the plurality of binder rings has two portions that are configured to be opened and closed via a manually operable lever.
